(19) United States
(12) Patent Application Publication
(10) Pub. No.: US 2013/0018514 A1
(43) Pub. Date: Jan. 17, 2013

(54) SUBSEA ELECTRONICS MODULES

(71) Applicants: Ravi Shankar Varma Addala, Hyderabad (IN); Ji Dong, Nailsea (GB)

(72) Inventors: Ravi Shankar Varma Addala, Hyderabad (IN); Ji Dong, Nailsea (GB)

(21) Appl. No.: 13/543,355

(22) Filed: Jul. 6, 2012

(30) Foreign Application Priority Data
Jul. 6, 2011 (EP) 11172923.2

(51) Int. Cl. G05D 7/00

(52) U.S. Cl. 700/282

(57) ABSTRACT

A subsea electronics module comprises a plurality of processors for controlling operations in a subsea hydrocarbon extraction well, the processors being coupled to a data highway and there being distributed software in the module for controlling the processors so that the function of at least one of the processors may be carried out at least in part by at least one of the other processors.

### BACKGROUND OF THE INVENTION

Embodiments of the present invention relate to subsea electronics modules.

The typical configuration of an offshore oil or gas well comprises a topside master control station (MCS) with subsea control equipment installed on the seabed. The MCS provides an interface for the operator with the subsea equipment and displays the current state of the various pieces of equipment and sensor information, enabling the operator to control the overall subsea system. The MCS is connected to a subsea control module (SCM) which is installed on a Christmas tree on the seabed and controls all the subsea control processes, providing hydraulic power to actuate valves mounted on the Christmas tree and at the wellhead. It also receives process instrumentation signals from sensors mounted on the Christmas tree and at the wellhead. These signals are received and processed in an electronics module (SEM) housed within the SCM and the resultant data is then transmitted to the MCS.

In early offshore well control systems, all software was housed in the MCS installed topside and the SEM consisted of bespoke hardware only. It was not until the mid-1990s that the SEM design combined hardware and embedded software. Since then, the requirements placed on offshore well control systems have become more complex and much additional functionality has had to be built into the SCM and in particular the SEM.

The ability to increase the functionality of an SEM to cater for different and increasingly complex control and instrumentation requirements has resulted in modular designs incorporating embedded software. For this purpose, an SEM is normally microprocessor based, employs a modular design comprising several printed circuit boards (PCBs), each having a specific function such as: communication with the MCS; interfacing with instrumentation and sensors; controlling valves and hydraulics; and equipment health monitoring, each PCB containing embedded software. A data highway is utilised within the SEM to provide communications between the various PCBs.

The SEM functionality required for complex control systems can result in heavy software loading in the processors housed on the individual PCBs in the SEM and this in turn can lead to operational problems and reduce reliability.

As prior art in the subsea field, there may be mentioned: U.S. Pat. No. 7,261,162; US 20040262008; US 20070107907; US 20100220773; US 20100202541; U.S. Pat. No. 7,768,908; US 20090296428; U.S. Pat. No. 7,576,447; WO 2009001024; WO 2008125793; WO 2007011230; US 20060064256; WO 05081077; US 20050232145; US 20050185349; and WO 04003328.

It will be appreciated that, generally speaking, a processor of a PCB of an SEM has either a monitoring function (such as reading data from devices such as in the form of sensors) or a device control function (such as interpreting commands and controlling the operation of devices such directional control valves (DCVs) for example). Each of these functions can be split between two stages, i.e. a reading stage or an operating stage respectively (hereinafter called “electronic accessing”) and a data processing stage or a control stage using a control algorithm respectively (hereinafter called “computing”). Conventionally, each of these stages are not separated but are carried out by a single processor of a PCB.

The above is schematically shown in FIG. 1, in which a subsea PCB of an SEM has a processor P for carrying out “electronic accessing” and “computing” in respect of various devices, which could be sensors or directional control valves for example.

In practice, of course, an SEM has several PCBs and FIG. 2 shows schematically two PCBs A and B, the processor PA of PCB A carrying out “electronic accessing” and “computing” in respect of devices 1, 2 and 3 and the processor PB of PCB B carrying out “electronic accessing” and “computing” in respect of devices 4, 5 and 6, reference numeral 7 designating a data highway in the form of an Ethernet bus to which the PCBs and processors of the SEM are coupled. The processors have substantially the same processing power or ability and it could be the case that, for processor PA, the software load for both “electronic accessing” and “computing” is too large for the processing power or ability of processor of PA, whereas for processor PB that software load is within the processing power or ability of processor PB.

One solution would be, in such a case, to change the design of the processor PA, for example using a more powerful one. However, if processor PB is unchanged, this would lead to significant effort and cost in managing and maintaining different sets of software and if processor PB is replaced as well with a more powerful one, this adds to cost and greater consumption of power.

Another situation is shown schematically in FIG. 3. In this case, one of processors PA and PB acts on devices 1, 2 and 3, PCB B being a redundant PCB used if the other fails. There are conventionally two ways to operate—let a decision be made topside as to which PCB to use (but if it fails it can take time to bring the other into operation) or have a complex algorithm running between the processors of the PCBs, for example a token between them, but considering that the processors might have limited computing ability, developing such an algorithm entails costs.

### BRIEF DESCRIPTION OF THE INVENTION

According to an embodiment of the present invention, there is provided a subsea electronics module comprising a plurality of processors for controlling operations in a subsea hydrocarbon extraction well, the processors being coupled to a data highway and there being distributed software in the module for controlling the processors so that the function of at least one of the processors may be carried out at least in part by at least one of the other processors.

According to an embodiment of the present invention, there is provided a method of using a subsea electronics module comprising a plurality of processors to control operations in a subsea hydrocarbon extraction well, the processors being coupled to a data highway, the method comprising using distributed software in the module to control the processors so that the function of at least one of the processors is carried out at least in part by at least one of the other processors.

### BRIEF DESCRIPTION OF THE DRAWINGS

FIG. 1 shows schematically a PCB of an SEM and devices associated with it;

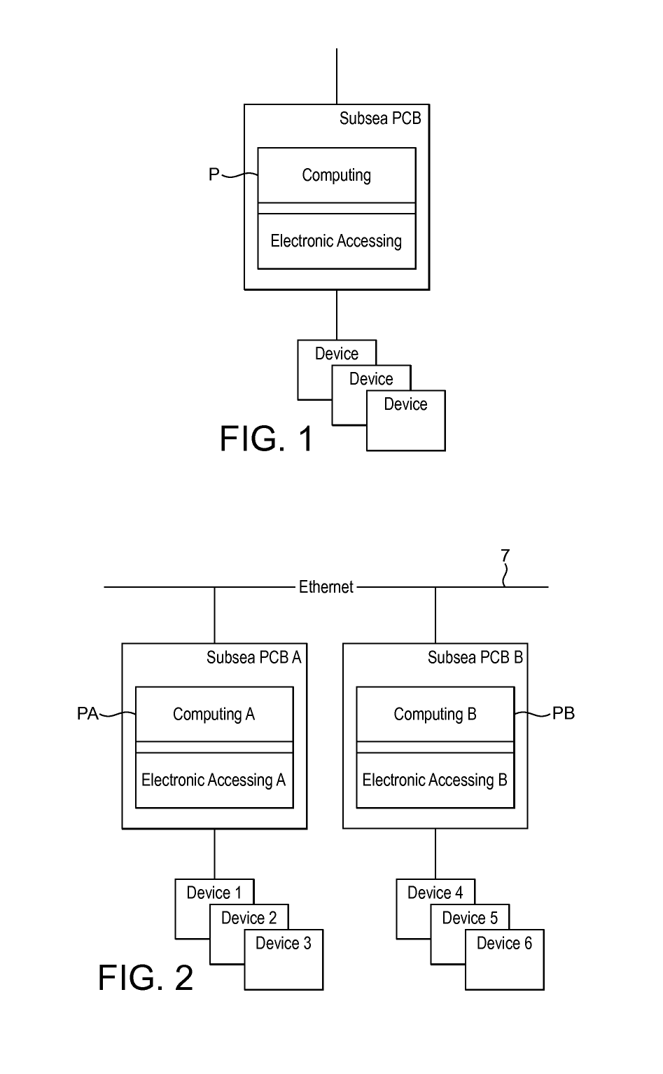

FIGS. 2 and 3 show schematically two configurations of PCBs of an SEM;

FIGS. 4, 5 and 6 show schematically alternative configurations in accordance with embodiments of the invention; and

FIG. 7 shows schematically the configuration of an SEM to which the invention may be applied.

### DETAILED DESCRIPTION OF THE EXEMPLARY EMBODIMENTS OF THE INVENTION

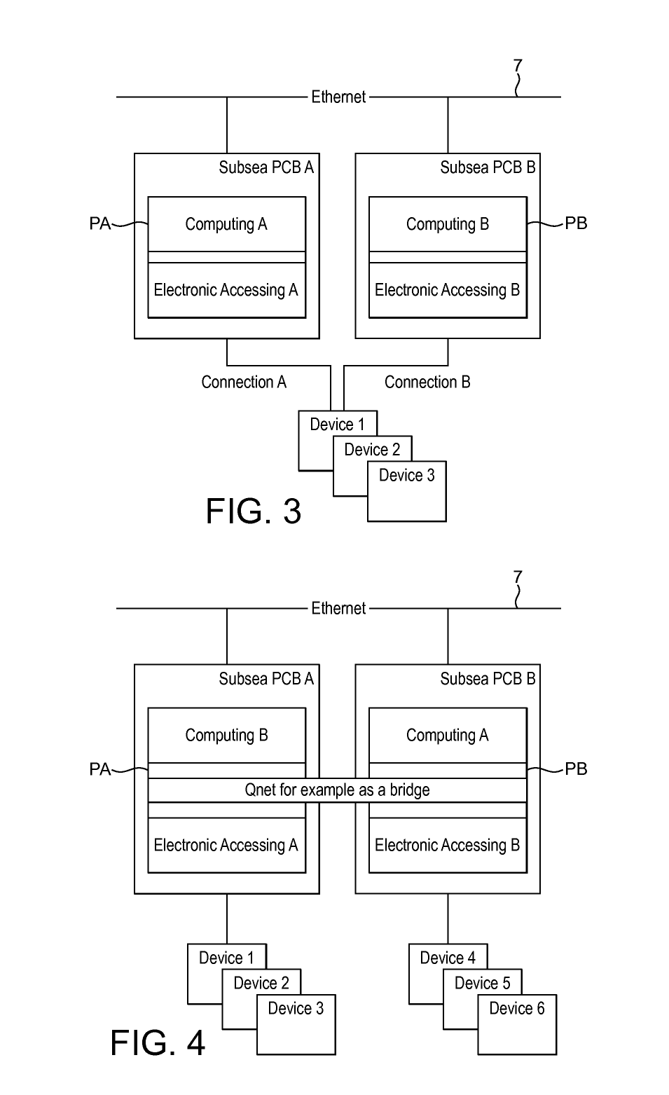

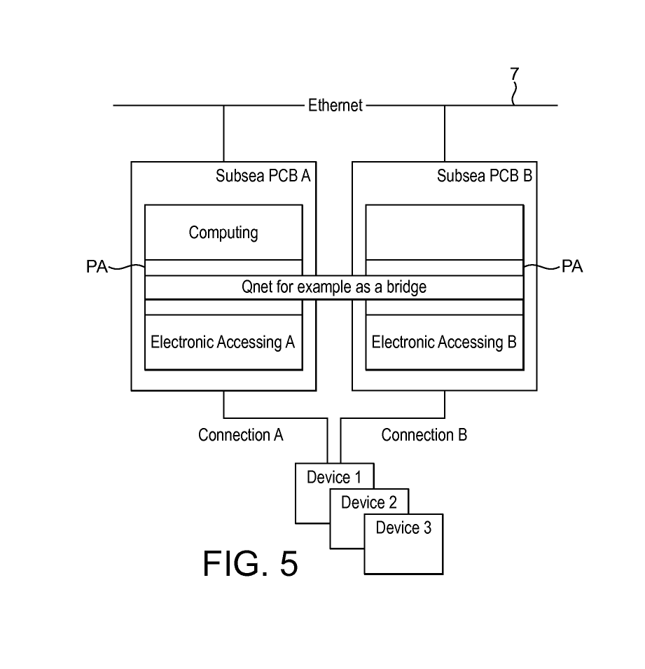

In FIG. 4, items which correspond with items in FIG. 2 have the same reference numerals as in FIG. 2 and in FIGS. 5 and 6, items which correspond with items in FIG. 3 have the same reference numerals as in FIG. 3.

Referring first to FIG. 4, it is assumed that the software load for “electronic accessing” and “computing” in respect of devices 1, 2 and 3 is greater than the processing power or ability of processor PA but the software load for “electronic accessing” in respect of devices 1, 2 and 3 and “computing” in respect of devices 4, 5 and 6 is within the processing power of processor PA. Also, the software load for “electronic accessing” in respect of devices 4, 5 and 6 and the software load for “computing” in respect of devices 1, 2 and 3 is within the processing power or ability of processor of PB. Accordingly: processor PA carries out “electronic accessing” in respect of devices 1, 2 and 3 and “computing” in respect of devices 4, 5 and 6; and the processor PB carries out “electronic accessing” in respect of devices 4, 5 and 6 and “computing” in respect of devices 1, 2 and 3, there being distributed software in the SEM to enable the above and acting as a bridge between the processors via the data highway 7, which may be an Ethernet bus, as in the following embodiments. Such software may be provided, as in the following embodiments, by a QNX real time software operating system utilising the Qnet protocol.

FIG. 5 shows schematically a first arrangement as an alternative to that of FIG. 3, only “computing” being carried out by the processor PA but “electronic accessing” being carried out by a chosen one of the processors. Again, the distributed software acts as a bridge via data highway 7, the logic of the software deciding whether connection A or connection B to the devices 1, 2 and 3 is to be used, the operator only needing to send a command to PCB A.

FIG. 6 shows schematically a second arrangement as an alternative to that of FIG. 3, to provide for redundancy and deal with the problems of FIG. 3, and corresponds with that of FIG. 4 except that “computing” is carried out by both the processors PA and PB so that if one PCB fails, operation will continue. The operator can send a command to either processor which will be executed even if one of PCBs A and B has failed but the other has not.

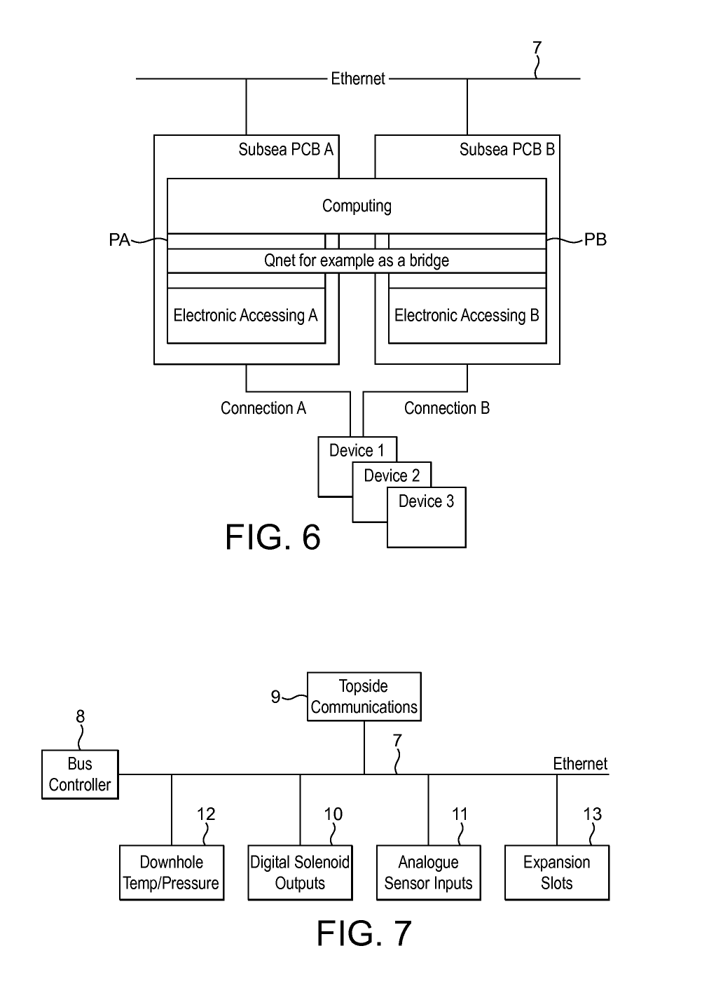

FIG. 7 shows schematically the functional configuration of a typical SEM in practice. It utilises industrial grade components and is housed in an SCM of the control system of a subsea hydrocarbon extraction well. The SEM has a modular construction and comprises a series of PCBs connected via the highway 7, each of which has a dedicated function.

Typically, the PCBs include: a multifunction bus controller PCB 8, which controls the operation of the data highway 7, the latter reducing the internal interconnections between the various PCBs in the SEM and enabling fast and reliable transfer of data; a communications PCB 9, which transmits all sensor data gathered by the SEM to the MSC and receives control commands from the MSC to open and shut valves, etc.; a digital output PCB 10, which provides digital drives to solenoids which open and shut valves; an analogue input PCB 11, which receives data from sensors mounted on the Christmas tree and at a manifold, and a downhole temperature and pressure (DHTP) input PCB 12, which receives temperature and pressure data from sensors mounted downhole in the well.

There are also usually expansion slots 13, to cater for additional PCBs should additional functionality be required.

The SEM employs the QNX real time software operating system, which is a microkernel based distributed software operating system and utilises the Qnet protocol which has been specifically designed for real time embedded software applications and caters for distributed processing to control the processors on the PCBs 8-12 in accordance with any of the techniques described with reference to FIGS. 4, 5 and 6.

The kernel is the most important part of any software operating system and its function is to manage the processing resources and allow programs to run and use these resources. The traditional monolithic kernel used in the majority of operating systems handles most services including process and memory management, interrupts, input and output communications and file systems, etc. A microkernel is much smaller and handles only the basic process communication and input and output control, all other processes and applications being based on other processors or servers. It is this capability which makes the microkernel based operating system more suitable for real time embedded and distributed multi-processor systems

The distributed software could utilize the Qnet protocol.

One of said processors could carry out the same function as another of said processors, said software deciding which of them to use for said function.

Said software could be such that a first of said processors carries out a first function and a second of said processors carries out a second function, and at least part of the function of said first processor may be carried out by said second of the processors. In this case, said software could be such that said second of said processors may carry out at least part of the function of said first of said processors in dependence on the software loads of these processors resulting from the first and second functions. Typically, said software is then such that at least parts of the functions of said first and second processors may be shared between these processors.

Typically, the function of each of the processors comprises a first, operating or reading stage and a second, processing or control stage. In such a case, typically said software is such that each of such first and second processors carries out the first stage of its function.

Typically, said highway comprises an Ethernet bus.

Said processors are typically on printed circuit boards housed in the module.

Such printed circuit boards could comprise a controller board for controlling operation of said data highway.

Such printed circuit boards could comprise at least one of: a communications board for transmitting sensor data and receiving control commands; a board for providing drives for opening and closing valves; a board for receiving data from sensors on a tree and/or at a manifold; and a board for receiving downhole temperature and pressure data from downhole sensors.

Embodiments of the present invention enable the sharing of processor load between processors in an SEM, to avoid individual processor overloads and to share the software load in the most efficient manner during peak operations so that system performance is not compromised. This is achieved by the use of a distributed software operating system, such as QNX and its Qnet protocol, which enables distributed processors to communicate and share their resources efficiently

The use of the proposed software technique can result in one or more of the following. Software redundancy—which will lead to increased reliability. Given spare capacity on boards it is also possible to include critical software modules on more than one board so that, in the event of a failure of the main critical software package, the other package can be activated. An example of this would be the software for controlling directional control valves. Improved load management—more efficient load sharing between processors ensuring a uniform distribution of load across the software processors and possible improvement in reliability. Potential for the use of lower power consumption microprocessors which could reduce heat generation on PCBs, power consumption and reduce cost.

What is claimed is:

1. A subsea electronics module comprising a plurality of processors for controlling operations in a subsea hydrocarbon extraction well, the processors being coupled to a data highway and there being distributed software in the module for controlling the processors so that the function of at least one of the processors may be carried out at least in part by at least one of the other processors.

2. The module according to claim 1, wherein the distributed software utilizes the Qnet protocol.

3. The module according to claim 1, wherein one of the processors carries out the same function as another of the processors, the software deciding which of them to use for the function.

4. The module according to claim 1, wherein the software is such that a first of the processors carries out a first function and a second of the processors carries out a second function, and at least part of the function of the first processor may be carried out by the second of the processors.

5. The module according to claim 4, wherein the software is such that the second of the processors may carry out at least part of the function of the first of the processors in dependence on the software loads of the first and the second processors resulting from the first and second functions.

6. The module according to claim 4, wherein the software is such that at least parts of the functions of the first and second processors may be shared between the first and second processors.

7. The module according to claim 1, wherein the function of each of the processors comprises a first operating or reading stage and a second processing or control stage.

8. The module according to claim 7, wherein the software is such that each of the first and second processors carries out the first stage of its function.

9. The module according to claim 1, wherein the data highway comprises an Ethernet bus.

10. The module according to claim 1, wherein the processors are on printed circuit boards housed in the module.

11. The module according to claim 10, wherein one of the printed circuit boards comprises a controller board for controlling operation of the data highway.

12. The module according to claim 10, wherein the printed circuit boards comprise at least one of:
a communications board for transmitting sensor data and receiving control commands;
a board for providing drives for opening and closing valves;
a board for receiving data from sensors on at least one of a tree and at a manifold; and
a board for receiving downhole temperature and pressure data from downhole sensors.

13. A method of using a subsea electronics module comprising a plurality of processors to control operations in a subsea hydrocarbon extraction well and the processors being coupled to a data highway, the method comprising using distributed software in the module to control the processors so that the function of at least one of the processors is carried out at least in part by at least one of the other processors.

14. The method according to claim 13, wherein the distributed software utilizes the Qnet protocol.

15. The method according to claim 13, wherein one of the processors carries out the same function as another of the processors, the software deciding which of them to use for the function.

16. The method according to claim 13, wherein the software is such that a first of the processors carries out a first function and a second of the processors carries out a second function, and at least part of the function of the first processor is carried out by the second of the processors.

17. The method according to claim 16, wherein the software is such that the second of the processors carries out at least part of the function of the first of the processors in dependence on the software loads of these processors resulting from the first and second functions.

18. The method according to claim 16, wherein the software is such that at least parts of the functions of the first and second processors are shared between these processors.

19. The method according to claim 13, wherein the function of each of the processors comprises a first operating or reading stage and a second processing or control stage.

20. The method according to claim 19, wherein the software is such that each of the first and second processors carries out the first stage of its function.

21. The method according to claim 13, wherein the data highway comprises an Ethernet bus.

22. The method according to claim 13, wherein the processors are on printed circuit boards housed in the module.

23. The method according to claim 22, wherein one of the printed circuit boards comprises a controller board for controlling operation of the data highway.

24. The method according to claim 22, wherein the printed circuit boards comprise at least one of:
a communications board for transmitting sensor data and receiving control commands;
a board for providing drives for opening and closing valves;
a board for receiving data from sensors on at least one of a tree and at a manifold; and
a board for receiving downhole temperature and pressure data from downhole sensors.
